(19) United States
(12) Patent Application Publication
(10) Pub. No.: US 2010/0094473 A1
(43) Pub. Date: Apr. 15, 2010

(54) System For Detecting Load Loss Following An Electrical Power Disturbance

(75) Inventors: David Anderson, Victoria (CA); John C. Van Gorp, Sidney (CA)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: SQUARE D COMPANY, Palatine, IL (US)

(21) Appl. No.: 12/252,047

(22) Filed: Oct. 15, 2008

(51) Int. Cl. G06F 19/00

(52) U.S. Cl. 700/286

(57) ABSTRACT

A method of detecting an electrical load loss following an electrical power disturbance in a monitored electrical power distribution system comprises (1) determining an expected characteristic of a parameter representing normal operation of an electrical load receiving power from the electrical power distribution system, (2) detecting a disturbance in the monitored electrical power distribution system, and (3) determining whether the load, or power circuit, or a portion of the load or power circuit, was lost as a result of the disturbance, by evaluating an actual characteristic of the parameter after termination of the disturbance with respect to the expected characteristic of said parameter.

### FIELD OF THE INVENTION

The present invention relates to the detection of load losses following a power disturbance in an electrical power distribution system.

### BACKGROUND OF THE INVENTION

Momentary interruptions in electrical power supplied to loads can cause loads (or component loads within a load) to shut down, depending on the severity and length of the interruption. Load loss following such power disturbances may not be immediately detected, especially for non-critical loads or non-critical components within a load. Monitoring devices tracking individual loads can detect loads that shut down is following a power disturbance, but the loss of component loads may be missed if the change in energy use is within the normal operating range of the load. Further, non-critical loads sharing a common power circuit are often monitored at the circuit level rather than individually, and thus a loss of one such load on a circuit containing many loads may not be detected by the monitor tracking the power circuit.

One way to detect possible load loss is to monitor a parameter representing load operation (such as kW) and compare values of this parameter measured immediately before and after a detected power disturbance. Using this approach, a sudden drop in the measured parameter value following a power disturbance may indicate a loss of load. This approach, however, can fail to detect load loss when the parameter value measured immediately following a disturbance is the same or higher than before the disturbance, even though at least one load has been dropped (for example, when a disturbance causes one or more loads to restart, initially drawing more power than usual).

### SUMMARY OF THE INVENTION

In accordance with one embodiment, a method of detecting an electrical load loss following an electrical power disturbance in a monitored electrical power distribution system comprises (1) determining an expected characteristic of a parameter representing normal operation of an electrical load receiving power from the electrical power distribution system, (2) detecting a disturbance in the monitored electrical power distribution system, and (3) determining whether the load, or power circuit, or a portion of the load or power circuit, was lost as a result of the disturbance, by evaluating an actual characteristic of the parameter after termination of the disturbance with respect to the expected characteristic of said parameter.

In one implementation, the expected characteristic of the parameter is a statistical summary or model of multiple measured values of a first parameter versus a second parameter that is a driver of the normal operation of the load or power circuit. Examples of the first parameter are the energy consumption of the load or power circuit, or sub-loads within said load or power circuit, and examples of the second parameter are the time of day or the type of sub-load. Example of the statistical summary or model are a standard deviation from the mean of a set of measured values of said parameter, and amplitudes for different harmonic frequencies from a Fourier analysis of measured values for a load or power circuit.

One particular implementation generates a notification in response to a determination that the load or power circuit, or a portion of the load or power circuit, was lost as a result of the disturbance.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The invention may best be understood by reference to the following description taken in conjunction with the accompanying drawings, in which:

FIG. 1 is a block diagram of a monitored electrical power distribution system having multiple monitors and multiple loads.

FIG. 2 is a plot of variations in the amplitude of a load voltage as a function of time and including the occurrence of a power disturbance.

FIG. 3 is a plot of variations in kW or kW demand as a function of time and including the occurrence of a power disturbance, along with predetermined profile bounds for the voltage amplitude.

FIG. 4 is a pair of “equipment curves” defining a tolerable voltage envelope for a specified class of equipment, along with three measured voltage deviations from the nominal voltage.

FIG. 5 is a plot of energy consumption of a load or power circuit as a function of the hour of day.

FIG. 6 is a plot of energy consumption of a fan load as a function of whether the fan is on or off.

FIG. 7 is a plot of energy consumption of a load or power circuit as a function of temperature, and including a best-fit curve for the plotted data.

FIG. 8 is a graphic illustration of the results of a Fourier analysis of a set of energy consumption data grouped by the status of a fan load.

FIG. 9 is a plot of energy consumption of a packaged rooftop unit as a function of sub-loads within the rooftop unit.

FIG. 10 is a plot of energy consumption of a packaged rooftop unit as a function of temperature.

FIG. 11 is a plot of energy consumption of a power transformer as a function of harmonic frequency for a first portion of a day.

FIG. 12 is a plot of energy consumption of a power transformer as a function of harmonic frequency for a second portion of a day.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

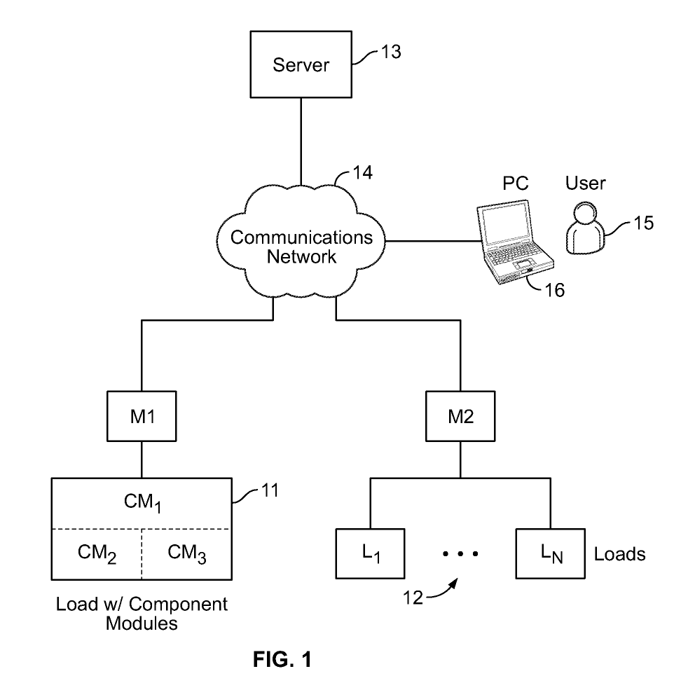

Turning now to the drawings and referring first to FIG. 1, a load loss detection system includes a pair of monitors M1 and M2 that perform measurements of at least one parameter (such as per-phase or phase-to-phase voltage) that can be used to detect a power disturbance. The monitor M1 is connected to a load 11 that includes several component loads CM1, CM2 and CM3, such as fans and cooling coils with HVAC equipment, and the monitor M2 is connected to a power circuit 12 that includes multiple loads L₁ . . . L_{N}. The monitors M1 and M2 also perform measurements of at least one parameter (such as kW or amps) that represents load and/or power circuit operation. The monitors M1 and M2 store the measured information and communicate it to a server 13 via a communications network 14. The server 13 also stores this information and performs load operation profiling, analysis and notification following a power disturbance. A user 15 may use a personal computer 16 connected to the communications network 14 to perform various functions such as analyzing parameter measurements from the monitors M1 and M2, configuring load operation profiles used in analyzing the power measurements, and configuring, sending and receiving notifications.

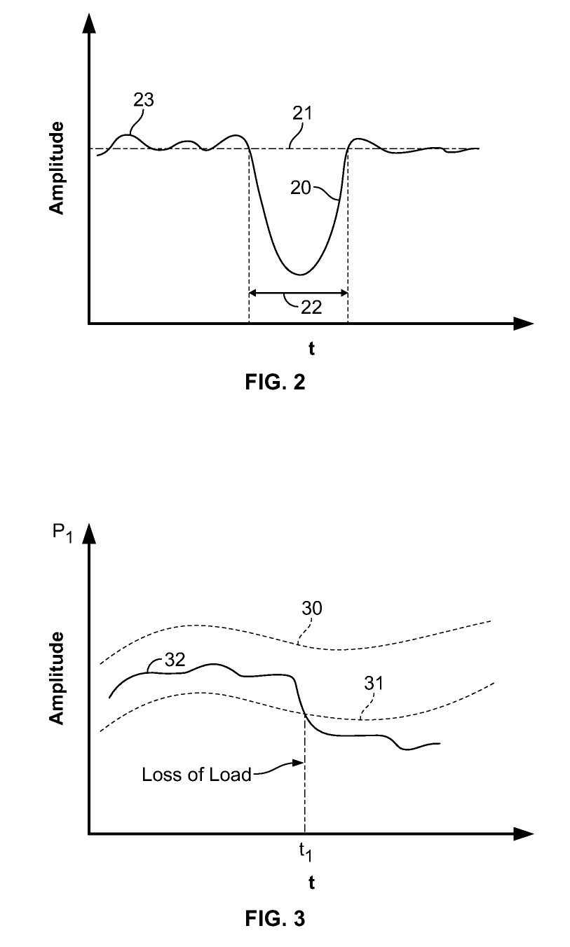

FIG. 2 illustrates a power disturbance represented by a decrease 20 in is the amplitude of a selected parameter below an expected nominal amplitude 21, with the disturbance having a duration 22. Parameters that can be used to detect power interruptions or disturbances are voltage per phase or voltage phase-to-phase, which typically vary little from a nominal value. In FIG. 2, the actual amplitude 23 of the parameter (shown as a solid line) varies slightly over time from the nominal amplitude 21 (shown as a dashed line). A power disturbance causes the actual amplitude 23 to suddenly dip below the nominal amplitude 21 for the time interval 22. Such disturbance intervals are typically sub-second and may range from some fraction of a power system cycle to well over a dozen or more cycles. As discussed above, such disturbances can cause the loss of all or part of a load or power circuit containing multiple loads.

FIG. 3 illustrates the use of “profiling” to detect the loss of a load on a monitored power circuit following a power disturbance. A “profile” defines one or more bounds of the expected operation (parameter trend characterization, equipment curves, harmonic characterization, delta change in parameter after event, etc.) of a power circuit containing multiple loads, in terms of one or more parameters. A profile of a parameter representing operation of a load or multiple loads on a circuit provides an indication of “expected” parameter values.

In FIG. 3, the area between a pair of profile bounds 30 and 31 (shown as dashed lines) represents the range of expected values for the amplitude of a parameter P1 (shown as a solid line 32) as a function of time t. The parameter P1 is a parameter representing operation of a load or multiple loads on a power circuit, such as the power in kW or kW demand. Following a detected power disturbance, the amplitude of the parameter P1 drops below the lower profile bound 31 at time t₁, signaling lower load values than expected and indicating a potential loss of load. Thus, the actual values of the amplitude of the parameter P1 following a power disturbance can be evaluated against the profile bounds 30 and 31 to assess the likelihood that any portion of the load or power circuit was lost as a result of the power disturbance.

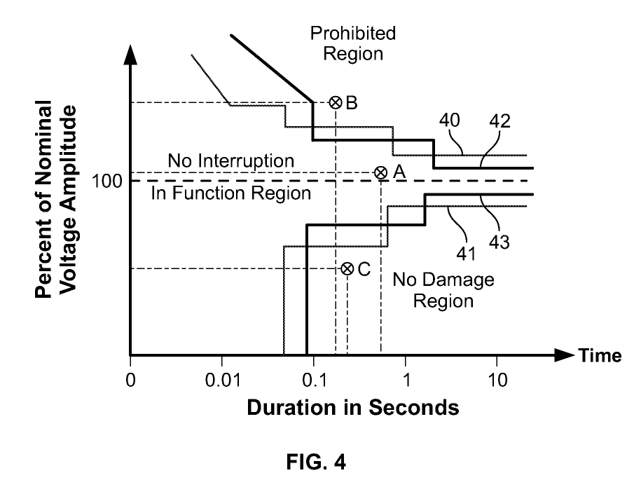

FIG. 4 illustrates a pair of standard “equipment curves” 40 and 41 defining regions of continuing operation and interrupted operation of a known class of equipment. In the illustrated example, the two curves 40 and 41 define an envelope (the area between the two curves) of AC input voltage amplitudes and durations that can be is tolerated by the equipment, i.e., voltage variations within this envelope will not cause an interruption in the function of the equipment. The vertical axis of FIG. 4 is the percent of nominal voltage amplitude (represented as 100 on the vertical axis), and the horizontal axis is the duration in seconds of a voltage deviation from the nominal voltage (using a logarithmic scale in the illustrated example).

Three measured deviations A, B and C from the nominal voltage are plotted in FIG. 4. Deviation A is within the tolerable envelope, deviation B is in the “prohibited” region above the curve 40, and deviation C is in the “no damage” region below the curve 41, where the function of the equipment is likely to be interrupted even though no damage is likely to occur. The server 13 is preferably programmed to send a notification, e.g., by email, of deviations B and C because these deviations are likely to impact load operation.

“Equipment curves” available in the literature define tolerable input voltage envelopes for different types or models of electrical equipment. Such curves are normally determined for broad classes of equipment after formal testing in a laboratory setting. Examples of such curves are the ITIC (formerly CBEMA) curves for information technology equipment on 120 VAC circuits.

FIG. 4 also includes a second pair of “equipment curves” 42 and 33 for a specific type or model of equipment, such as a specific computer server model. The derivation of such curves for a specific type or model of electrical load is typically based on records of the actual operation of such equipment following voltage disturbances. Records of equipment operation may be obtained in a number of ways, including manual logs, data captured by a monitoring device, and start/stop operation logs maintained by the equipment itself. For example, the equipment curves 42 and 43 in FIG. 4 may be derived after a number of voltage disturbances have been captured and correlated with equipment operation records. Once derived, equipment curves can be used to assess the impact of future voltage disturbances on equipment operation, such as the disturbances A, B and C discussed above.

Load profiling establishes “normal” operation for a load or a power circuit with a group of loads. Profiles can be developed using a number of different, complementary techniques (including regression analysis of a load parameter vs. some “driver” parameter that influences the load operation, and profiling of harmonic spectra). This profiling can also be combined with voltage disturbance curves for monitored equipment to assess whether a particular load is offline following a detected disturbance. A “load operation profile” describes an expected characteristic of a parameter selected to represent the normal operation of a load or power circuit receiving power from a monitored electrical power distribution system. In FIG. 3, for example, the area between the load profile bounds 30 and 31 represents the expected range of load operation as measured by the amplitude of the parameter P1. The bounds 30 and 31 may be based on a statistical summary of past P1 measurements, as described in more detail below. When the measured value of the amplitude of P1 exceeds these bounds, as occurs at time t₁ in FIG. 3, a notification can be generated and sent to preselected addresses. A second notification may also be sent when the measured value of the amplitude of the parameter P1 returns to values within the load profile bounds.

A load operation profile may take the form of a statistical summary or model of multiple measured values of a selected parameter. Two load profiling analysis approaches include: (a) the best fit of parameter P1 vs. parameter P2; and (b) a Fourier transform of parameter P1 (in terms of amplitude and frequency) vs. parameter P2.

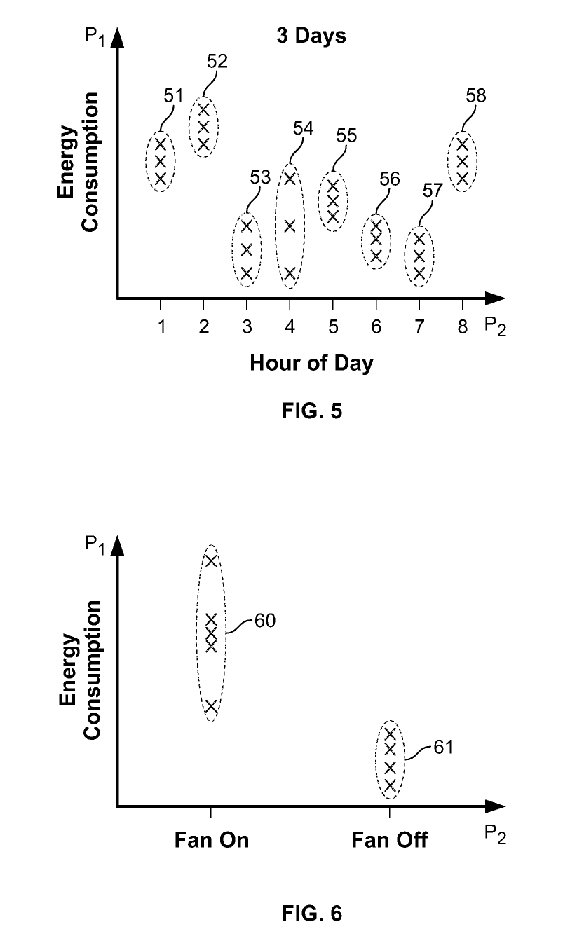

The best fit approach is illustrated in FIGS. 5-7. In FIG. 5, the magnitude of a parameter P1 such as energy consumption is plotted for each increment of a second parameter P2 such as the hour of day, for a period of three days (three values for each hour). It can be seen that the P1 values are grouped by P2 increments, as shown by the groups 51-58 in FIG. 5, and a statistical summary of the grouped values can be generated. In FIG. 5, the P1 values are grouped by the hour in the day in which they occur, and a statistical summary (such as the mean and standard deviation) for each group of values can be generated and used to establish load profile bounds. A standard deviation measures how widely spread the values in a data set are. If many data points are close to the mean, then the standard deviation is small and, conversely, if many data points are far from the mean, then the standard deviation is large. If all data values are equal, then the standard deviation is zero. A standard deviation is expressed in the same units as the data.

In the example shown in FIG. 6, parameter P2 is the state of a fan (on is or off) within a monitored load. Here again, the P1 values can be grouped by P2 values (fan on or off), as shown by the groups 60 and 61 in FIG. 6, and a statistical summary for each group of values can be generated and used to establish load profile bounds.

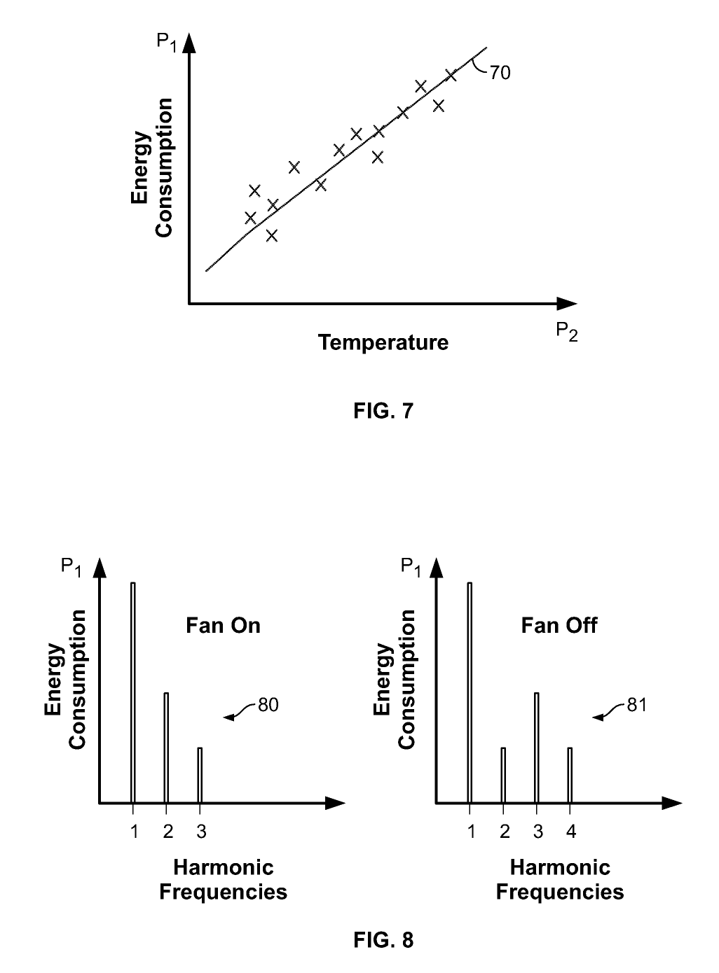

If there is a more continuous relationship between parameter P1 and parameter P2, a more traditional regression analysis may be performed, as illustrated in FIG. 7. Parameter P1 in FIG. 7 is energy consumption, and parameter 2 is temperature. A best-fit line or curve 70 can be determined and used to develop a load operation profile. This best-fit line 70 may be accompanied by other statistical summary information (such as a confidence interval) which can be used to establish load profile bounds.

The Fourier transform approach is illustrated by FIG. 8 for a Fourier analysis of parameter P1, grouped by values of parameter P2. In the example in FIG. 8, P1 values (energy consumption) are organized by values of P2 (the status of a fan), and a Fourier analysis is used to generate amplitude values within different harmonic frequency “bins.” A statistical analysis of amplitude values within each harmonic frequency bin can be used to develop the two illustrated harmonic spectrum profiles 80 and 81 for the two different states of the fan.

The load profiling approaches described above generate an “expected” range of values for a parameter selected to represent load operation, typically expressed in statistical terms such as mean, standard deviation and/or confidence interval. Load profile bounds can be based on selected statistical parameter values, and notifications generated when load parameter values exceed these bounds. As an example, if parameter P1 values are collected over the operating range of a load and are grouped by parameter P2 values, as described above, standard deviations can be calculated for each P1 grouping, and load profile bounds set at two standard deviations for each grouping.

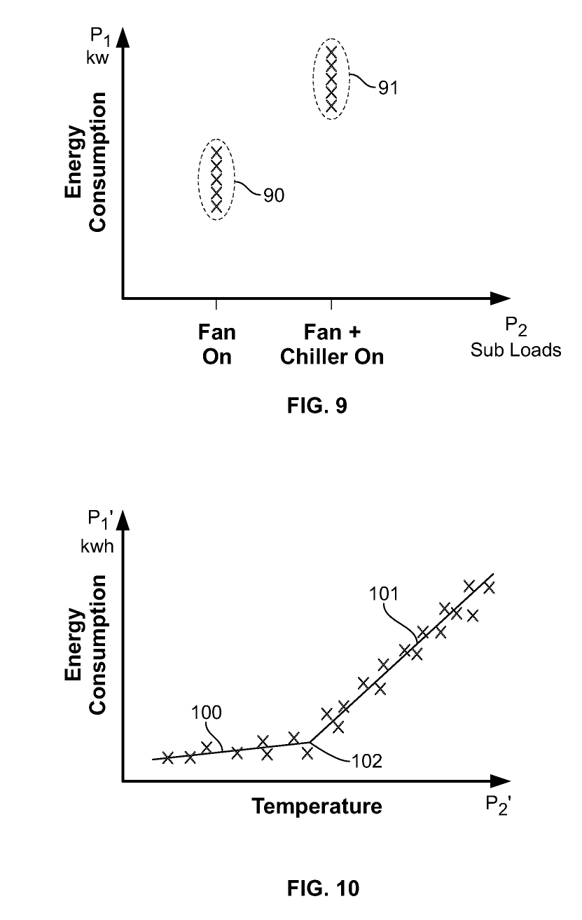

One or more of the approaches described above can be applied to develop load operation profiles that may be evaluated together to provide a comprehensive view of expected load operation. Two examples are illustrated in FIGS. 9-12.

In FIGS. 9 and 10, a packaged rooftop unit (RTU) example is illustrated by two load operation profiles. FIG. 9 profiles kW values (parameter P1) vs. is the on/off status of RTU load modules (parameter P2, e.g., fan, fan plus chiller), reflecting the fact that, when energized, the RTU either (a) turns on a fan, or (b) turns on both the fan and a chiller. The kW values fall within tight groups, as shown by the groups 90 and 91 in FIG. 9, and expected load operation bounds for these groups can be described by statistical summary parameters such as mean and standard deviation. If measured kW values fall outside these groups, one or more of the load modules may not be operating as expected.

FIG. 10 profiles kWh values (parameter P′1) vs. ambient temperature (parameter P′2), with a regression analysis generating two piecewise linear best-fit lines 100 and 101. FIG. 10 indicates that the RTU consumes more energy as the ambient temperature increases, with a greater rate of consumption after the “breakpoint” 102 formed by the junction of the two linear best-fit lines 100 and 101. One or more statistical summary parameters (such as a confidence interval) may be used to establish expected load operation bounds around both linear best-fit lines.

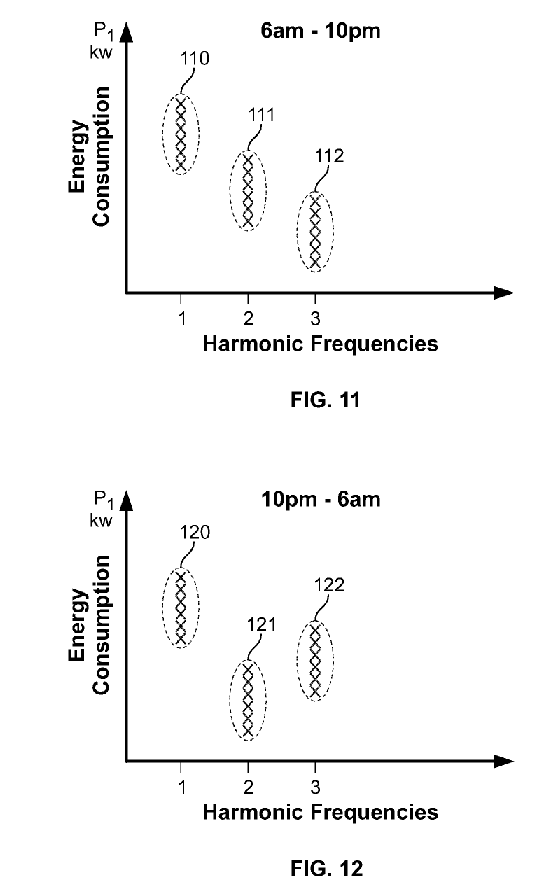

In FIGS. 11 and 12, a power transformer example is illustrated by two load operation profiles. In this example, a Fourier analysis is applied to total kW measurement values, with the kW values (parameter P1) grouped by two different time-of-day ranges (parameter P2), 6 AM to 10 PM in FIG. 11 and 10 PM to 6 AM in FIG. 12. The kW amplitude values captured at each harmonic frequency over the operating range of the power transformer are grouped by harmonic, as shown by the groups 110, 111 and 112 in FIG. 11 for 6 AM to 10 PM, and by the groups 120, 121 and 122 in FIG. 12 for 10 PM to 6 AM. One or more statistical summary parameters (such as mean and standard deviation) may be used to establish expected bounds for the kW values, by harmonic, for each time-of-day range. If Fourier analysis of measured kW values yields amplitude values that fall outside the bounds for any harmonic frequency, for the applicable time-of-day range, the power transformer may not be operating as expected. Note that this approach can be used to track both amplitude and frequency changes in load operation.

Load operation profiles generated using either of the two main approaches outlined above may be further manipulated by a user before being put into use by the system. As an example, a user may observe the kW vs. sub-load profile shown in FIGS. 9 and 10 and remove data points that occurred during a planned RTU maintenance outage.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A method of detecting an electrical load loss following an electrical power disturbance in a monitored electrical power distribution system, said method comprising
determining an expected characteristic of a parameter representing normal operation of an electrical load or power circuit receiving power from said electrical power distribution system,
storing said expected characteristic of a parameter in a computer memory,
measuring an actual characteristic of said parameter in said power distribution system,
storing said measured actual characteristic,
detecting a disturbance in said monitored electrical power distribution system, and
determining whether said load or power circuit, or a portion of said load or power circuit, was lost as a result of said disturbance, by evaluating said actual characteristic of said parameter after termination of said disturbance with respect to said expected characteristic of said parameter and outputting from said computer the results of said determination of whether said load or power circuit, or a portion of said load or power circuit, was lost as a result of said disturbance.

2. The method of claim 1 in which said expected characteristic of said parameter is a statistical summary or model of multiple measured values of said parameter.

3. The method of claim 2 in which said expected characteristic is a statistical summary or model of multiple measured values of a first parameter versus a second parameter that is a driver of the normal operation of said load or power circuit.

4. The method of claim 3 in which said statistical summary or model comprises amplitudes for different harmonic frequencies from a Fourier analysis of measured values for a load or power circuit.

5. The method of claim 3 in which said statistical summary or model comprises a standard deviation from the mean of a set of measured values of said parameter.

6. The method of claim 3 in which said first parameter is the energy consumption of said load or power circuit, and said second parameter is the time of day.

7. The method of claim 3 in which said first parameter is the energy consumption of sub-loads within said load or power circuit, and said second parameter is the type of sub-load.

8. The method of claim 1 which includes generating a notification in response to a determination that said load, or power circuit or a portion of said load or power circuit was lost as a result of said disturbance.

9. The method of claim 1 in which said expected characteristic comprises a normal range of values for said parameter, and said evaluating determines whether an actual value of said parameter after termination of said disturbance is within said normal range of values.

10. The method of claim 1 in which said expected characteristic of a parameter representing normal operation of an electrical load is at least one characteristic selected from the group consisting of a parameter trend characterization, equipment curves, harmonic characterization, and a characterization of the typical change in a parameter value following a disturbance.

11. The method of claim 1 in which said evaluating comprises comparing said expected characteristic with said actual characteristic of said parameter.

12. The method of claim 1 in which said expected characteristic is derived from records of the operation of a prescribed type of load following actual disturbances in the input voltage to said prescribed load.
